(19) United States
(12) Patent Application Publication
(10) Pub. No.: US 2015/0016623 A1
(43) Pub. Date: Jan. 15, 2015

(54) ACTIVE NOISE CANCELLATION METHOD FOR ENCLOSED CABINS

(71) Applicant: Lloyd Trammell, Thousand Oaks, CA (US)

(72) Inventor: Lloyd Trammell, Thousand Oaks, CA (US)

(73) Assignee: Max Sound Corporation, La Jolla, CA (US)

(21) Appl. No.: 14/182,188

(22) Filed: Feb. 17, 2014

Related U.S. Application Data
(60) Provisional application No. 61/765,619, filed on Feb. 15, 2013.

(51) Int. Cl. G10K 11/178

(52) U.S. Cl. CPC G10K 11/178
USPC 381/71.4; 381/71.8

(57) ABSTRACT

A Noise Cancellation Process for enclosed cabins is disclosed. According to one embodiment, an input audio source corresponding to sound received from multiple microphones situated equidistantly in both directions in a two dimensional plane, is converted to a digital signal via an analog to digital (A/D) convertor. The A/D converted audio is analyzed for content to identify ambient noise. The frequency, amplitude and phase of the identified ambient noise is subsequently determined. A Noise correction sound wave is generated with negative phase of that corresponding to the identified ambient noise. The noise correction sound wave is added to the identified noise to create a noise corrected sound.

### CROSS-REFERENCE TO RELATED PATENT APPLICATIONS

Embodiments of the present invention relate to U.S. Provisional Application Ser. No. 61/765,619 filed Feb. 15, 2013, entitled “ACTIVE NOISE CANCELLATION”, the contents of which are incorporated by reference herein and which is a basis for a claim of priority.

### BACKGROUND OF THE INVENTION

The present invention relates to a method and device for enhancing an audio source by reducing and eliminating background and other ambient noise in the sound wave, especially in enclosed cabins such as those found in airplanes, autos, ships, trains, homes and similar structures.

Listening environments typically include interference from surrounding audio sources such as people, devices, motions, etc., which prevent a listener from experiencing the best sound from the intended audio source. The term noise cancellation or noise control is conventionally used to describe the process of minimizing or eliminating sound emissions from sources that interfere with the listeners' intended audio source, often for personal comfort, environmental considerations or legal compliance.

Conventionally, attempts at noise control and cancellation are performed via active or passive means. Active noise control is sound reduction using a power source. Passive noise control refers to sound control by noise-reduction materials, such as insulations and sound-absorbing tiles typically used in homes and offices or moving vehicles, mufflers used in automobiles and the like, rather than a power source.

Active noise canceling is best suited for low frequencies. However, as the target frequencies intended to be reduced become higher, the spacing requirements for free space and zone of silence techniques become prohibitive. This is mostly because the number of modes grows rapidly with increasing frequency, which quickly makes active noise control techniques unmanageable. Therefore, at such higher frequencies, passive treatments become more effective and often provide an adequate solution without the need for active control.

Conventional active noise reduction techniques involve recognizing the noise in the transmitted or received signal¹. According to the conventional method, once the noise signal is recognized, it is reduced and removed by subtracting it from the transmitted or received signal. This technique is implemented using a digital signal processor (DSP) or software. Adaptive algorithms are designed to analyze the waveform of the background aural or non-aural noise, then based on the specific algorithm generate a signal that will either phase shift or invert the polarity of the original signal. This inverted signal (in anti-phase) is then amplified and a transducer creates a sound wave directly proportional to the amplitude of the original waveform, creating destructive interference. This effectively reduces the volume of the perceivable noise.² ¹ http://en.wikipedia.org/wiki/Active noise control (internal citations and quotation marks omitted)² See, n.1, above.

A noise-cancellation speaker may be co-located with the sound source to be attenuated. In this case it must have the same audio power level as the source of the unwanted sound. Alternatively, the transducer emitting the cancellation signal may be located at the location where sound attenuation is wanted (e.g. the user's ear). This requires a much lower power level for cancellation but is effective only for a single user.³ ³ See, note 1, above.

The conventional noise reduction systems suffer from many deficiencies. For example, noise cancellation becomes more difficult as the three dimensional wave-fronts of the unwanted sound and the cancellation signal could match and create alternating zones of constructive and destructive interference, reducing noise in some spots while doubling noise in others. In small enclosed spaces (e.g. the passenger compartment of an automobile) global noise reduction can be achieved via multiple speakers and feedback microphones, and measurement of the modal responses of the enclosure, but reduction in larger spaces is more problematic.⁴ ⁴ See, n.1, above.

A new noise cancelation method and process is required that addresses the above noted deficiencies of the conventional noise reduction methods.

### SUMMARY OF THE INVENTION

The Active Noise Cancellation (“ANC”) of the present invention is a system consisting of both analog and digital components that is specifically designed for reducing and eliminating ambient noise in an enclosed cabin environment of various sizes and shapes, such as those found in aircrafts, ships, trains, automobiles and even homes. The method and system is dynamic in that it continuously monitors and changes as the ambient noise in the cabin changes.

The inventive ANC system includes two or more microphones that are placed in the target cabin in which noise reduction is sought, preferably the microphones are situated in equal distances in the horizontal and perpendicular directions corresponding to a two-dimensional plane. Each microphone monitors sound waves in its corresponding zone and the overlaps of any of its surrounding zones. The number of microphones and zones will be determined by the size of the enclosed cabin the system is used in. Preferably, the microphones are of the Cardioids type.

The signals from the microphones are fed to an analog to digital converter, which converts the analog signals received from the microphones to digital signals. The converted digital audio is analyzed for content and ambient noise is identified for further processing. The ambient noise is monitored for changes. There could be a single or multiple noise frequencies that are identified and subsequently monitored.

Changes to the amplitude, frequency and phase of the ambient noise are subsequently performed as necessary. Phase Modulator dynamically changes the phase of the ambient noise, always in a negative amount, of the digital audio received. The negative phase sound is added back to the original noise which results in a reduction or cancellation of the sound wave corresponding to the noise. These changes are dynamic and self adjusting in nature. The modified, noise corrected digital sound output is changed back to an analog signal and fed into the audio playback system for noise reduction.

### BRIEF DESCRIPTION OF THE DRAWINGS

FIG. 1(a) is a block diagram of an exemplary embodiment of the Active Noise Cancellation Module according to the present invention.

FIG. 1(b) is a block diagram of an exemplary embodiment showing a system incorporating Active Noise Cancellation Module according to the present invention.

FIG. 2 is an illustration of an exemplary application of the Active Noise Cancellation Module according to the present invention.

FIGS. 3(a) and 3(b) are exemplary illustrations of how the inventive process determines and differentiates noise from desirable audio.

### DETAILED DESCRIPTION OF THE PREFERRED EMBODIMENT(S)

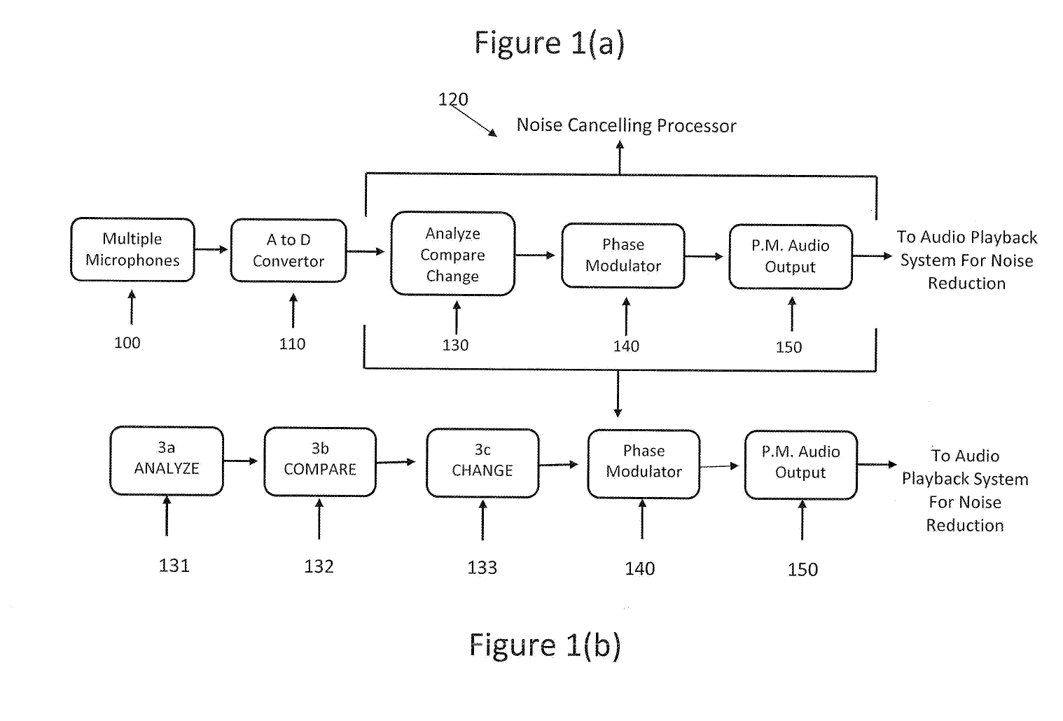

An embodiment of the operation of the Active Noise Cancellation technique of the present invention is depicted in the block diagram of FIG. 1. Preferably, the inventive ANC process is performed by a single module identified by reference numeral 130 in the system shown in the block diagram of FIG. 1.

As shown in FIG. 1, multiple microphones 100 provide the input audio source received for further analysis and processing. Preferably, the microphones are of the Cardioid type. The microphones are spaced in the enclosed cabin in which the noise reduction is being performed in equal distances from each other in a two dimensional lateral and perpendicular directions.

The input audio from these Multiple Microphones 100 is fed to an analog-to-digital (A/D) convertor 110, where the input audio analog signal is converted to a digital format.

The converted digital audio from the A/D convertor 110 is fed to the inventive Noise Cancelling Processor (NCP) module 120 for processing. The Noise Cancellation Processor Module 120 performs several steps on the sound wave it receives from the A/D converter which will ultimately result in an audio sound with reduced or cancelled ambient noise levels.

In the Analyze step 131, A/D converted audio sound 110 is analyzed for content and ambient noise is identified. Once the noise wave is identified, it is further analyzed for frequency, amplitude and phase values. The Compare step 132 monitors the amplitude, frequency and phase of the original sound wave for changes to ambient noise are subsequently performed as needed to identify any additions or changes to the determined noise. The Change step 133 identifies any changes that are needed to be made to the incoming digital noise in both positive and negative direction, in the identified ambient noise.

Phase Modulator step 140 dynamically changes the phase of the identified ambient noise, in a negative amount, and creates a new noise correction wave based on the digital audio received. These changes are dynamic and self adjusting in nature.

Phase Modulator Audio Output step 150 is a phase modulated audio output (digital or analog) that feeds into the existing audio system in the enclosed cabin. In this step the modified noise output from the Phase Modulator 130 is added back to the original noise in a phase shift of 90 to 180 degrees as needed to cancel out the input noise. The resulting combination of the original noise sound waves and the newly created noise correction wave will result in a reduction and cancellation of the noise present in the original audio sound. This Phase Modulation is a constantly changing amount. The amount of change is derived from the analyzing of the input noise and its amplitude plus harmonic content.

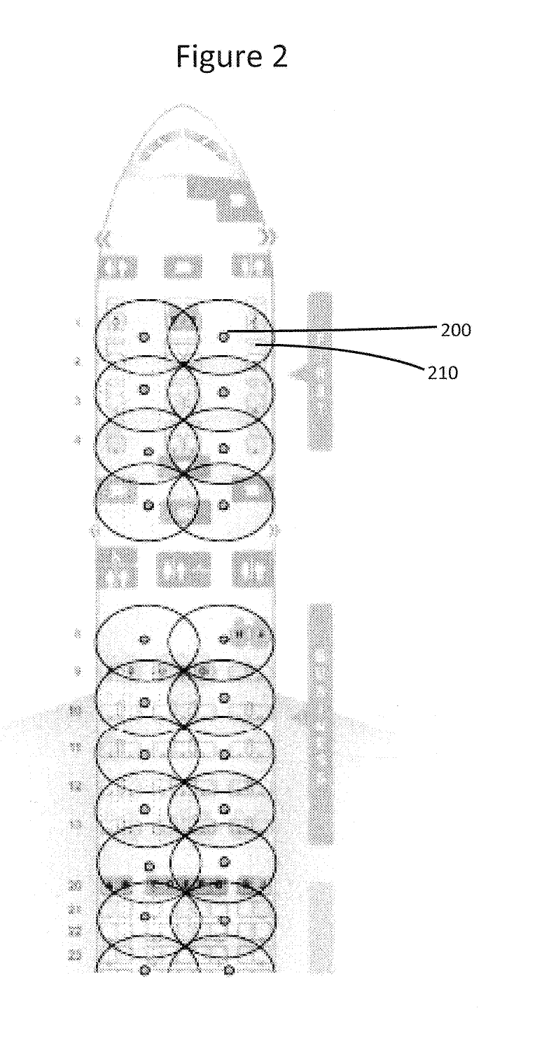

FIG. 2 shows an exemplary embodiment of the present invention in an airplane setting. Preferably, microphones 300 are placed equidistantly in the lateral and perpendicular directions. Zones 310 corresponding to microphones 300 are identified.

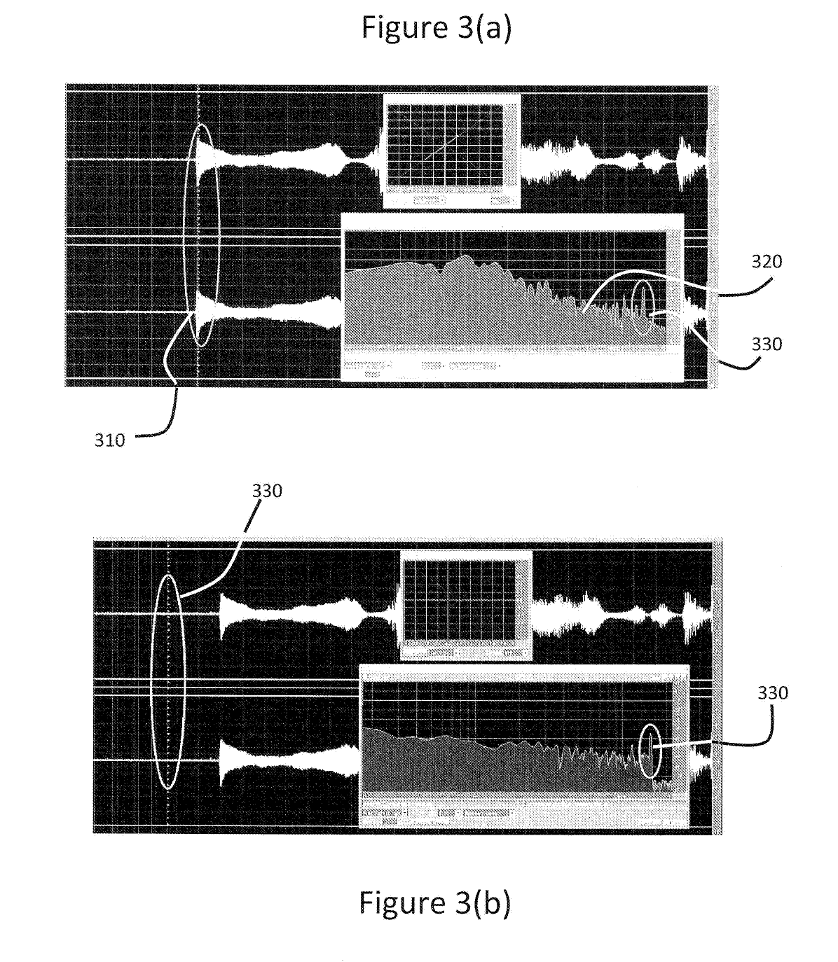

FIGS. 3(a) and 3(b) show an exemplary illustration of how the inventive process determines and differentiates noise from desirable audio. The Figures show examples of audio that includes a small amount of noise. 310 and 320 refer to the desired audio in this example. 330 identifies the audio noise in this example, which is also identified by the circles in FIG. 3(b). This particular noise is about 15.5 kHz with a narrow bandwidth, as most noise is. This spike will continue to appear through the audio clip thus identifying it as something that is constant and needs to be removed.

Although the present example discusses a single noise frequency, the invention is not limited in that way and there can be multiple noise frequencies that need to be removed. Once identified as “noise” the process will analyze for the frequency, amplitude, and phase. At this point, negative audio will be generated and summed with the original audio thus cancelling the offending “noise”. The original will continue to be monitoring the offending frequencies and if there is any change, the process will make the same change, but in a negative direction to make sure that the noise is effectively cancelled out. This will continue to dynamically monitor and generate audio until there is no input or it is bypassed. Accordingly, when the phase of the noise changes, so does the amount of negative phase audio.

What is claimed is:

1. A Noise Cancellation Process for an enclosed cabin environment comprising:
Providing an input audio source from an enclosed cabin;
Converting the input audio source to a digital signal via an analog to digital (A/D) convertor;
Analyzing the A/D converted audio for content and identifying ambient noise;
Determining frequency, amplitude and phase of the identified ambient noise;
Generating a noise correction sound wave with negative phase of that corresponding to the identified ambient noise;
Summing the noise correction sound wave and the identified noise sound wave to create a noise corrected audio sound wave;
Outputting the noise corrected audio sound with diminished noise.

2. The Noise Cancellation Process of claim 1 wherein the negative phase is a phase shifted wave with a shift of between 90 and 180 degrees from the original phase amount.

3. The Noise Cancellation process of claim 1 further comprising monitoring the A/D converted audio for changes in the ambient noise and identifying any additional noise waves.

4. The Noise Cancellation Process of claim 1, wherein the input audio source is received from multiple microphones situated in the enclosed cabin.

5. The Noise Cancellation Process of claim 4, wherein the microphones are of Cardiod type.

6. The Noise Cancellation Process of claim 4, wherein the enclosed cabin is an airplane cabin.

7. The Noise Cancellation Process of claim 6, wherein the microphones are of distributed equidistantly in the horizontal and perpendicular dimensions corresponding to a two dimensional plane.
